(19) United States
(12) Patent Application Publication
(10) Pub. No.: US 2004/0202827 A1
(43) Pub. Date: Oct. 14, 2004

(54) RECORDING MEDIUM, AND RECORDING METHOD USING THE SAME

(76) Inventor: TERUAKI OKUDA, TOKYO (JP)

Correspondence Address: FITZPATRICK CELLA HARPER & SCINTO, 30 ROCKEFELLER PLAZA, NEW YORK, NY, 10112, US

(21) Appl. No.: 09/472,988

(22) Filed: Dec. 28, 1999

(30) Foreign Application Priority Data
Jan. 7, 1999 (JP) 001832/1999

(51) Int. Cl. B41M 5/00

(52) U.S. Cl. 428/195.1; 428/204; 347/105

(57) ABSTRACT

A recording medium includes at least an ink receiving layer containing an inorganic pigment, and an outermost surface layer containing a thermoplastic latex resin. The ink receiving layer and the outermost surface layer are provided on each of both surfaces of a substrate in this order.

### BACKGROUND OF THE INVENTION

1. Field of the Invention

The present invention relates to a recording medium having an outermost surface layer which contains a latex resin.

2. Description of the Related Art

An image obtained according to a conventional ink-jet recording method has problems in that, for example, the image tends to discolor or fade by light or ozone, or to blur in contact with water. Another problem is that the glossiness of the visual image is insufficient.

Japanese Patents Laid-Open Application (Kokai) Nos. 7-237348 (1995) and 8-2090 (1996) disclose that, in order to improve the water resistance and weather resistance of the image, a latex layer is provided on an ink absorbing layer of a recording medium, and a transparent film is produced by heating the latex layer after ink-jet recording.

However, the above-described conventional approach of producing the transparent film on the recording medium by heating the latex layer by applying hot air after ink-jet recording has a problem in that the recording medium curls. Since nonnuniform heating is a cause of curling, a method has been proposed in which a transparent film is uniformly and efficiently produced from the latex layer by heating the recording medium by two heated rubber rollers while pressing the recording medium from two sides. However, even such a recording medium curls after being left in a high-temperature and high-humidity environment.

### SUMMARY OF THE INVENTION

It is an object of the present invention to provide an image recording medium which does not curl irrespective of environment where it is left, and which has excellent image recording properties.

According to one aspect of the present invention, a recording medium includes at least a substrate, an ink receiving layer containing an inorganic pigment, and an outermost surface layer containing a thermoplastic latex resin in this order. The ink receiving layer and the outermost surface layer are provided on each of both surfaces of the substrate.

According to another aspect of the present invention, a recording method includes the steps of performing ink-jet recording on the above-described recording medium, and heating the recording medium after the ink-jet recording.

The foregoing and other objects, advantages and features of the present invention will become more apparent from the following detailed description of the invention.

### DETAILED DESCRIPTION OF THE INVENTION

A recording medium according to the present invention includes an ink receiving layer containing an inorganic pigment on each of both surfaces of a substrate. An outermost surface layer containing a thermoplastic latex resin is provided on the ink receiving layer.

Ordinary paper, coated paper, baryta paper or the like may be used as the substrate. Baryta paper is preferable in order to obtain a high-quality image having high whiteness. The weighing capacity of baryta paper is preferably 100 g/m²-250 g/m².

A vinyl chloride, vinyl chloride-vinyl acetate, SBR (styrene-butadiene rubber), NBR (acrylonitrile-butadiene rubber), acrylic, urethane, polyester or ethylene latex may be used as the latex for the outermost surface layer. A vinyl chloride-vinyl acetate latex is preferable in consideration of ink permeability. The average particle size of the latex is preferably 0.1-1.0 μm. The amount of coating of the outermost surface layer is preferably 3-10 g/m².

The ink receiving layer provided between the outermost surface layer and the substrate must completely and rapidly absorb ink passing through the latex of the outermost surface layer. Hence, the ink receiving layer is made of a porous substance including an inorganic pigment and a binder. The amount of coating of the ink receiving layer is preferably 10-40 g/m².

Light calcium carbonate, aluminum hydroxide, synthetic alumina, amorphous silica or the like may be used as a pigment having a large ink absorptivity. In order to obtain a high-quality image with a recording medium having a large ink absorptivity, a porous layer containing alumina hydrate is preferable as the ink receiving layer. Polyvinyl alcohol, starch, polyvinyl pyrolidone, carboxymethyl cellulose, hydroxyethyl cellulose, SBR latex, NBR latex or the like is preferably used as the binder.

The mixing ratio of the inorganic pigment and the binder is preferably 10 weight parts of the inorganic pigment to 0.5-5 weight parts of the binder.

For providing a recording medium according to the present invention, first, a coating liquid is prepared by dissolving or dispersing materials for forming each layer in water, alcohol or any other appropriate organic solvent. The recording medium of the invention is obtained by coating the coating liquid on the surface of the substrate using a roll coater, a blade coater, an air-knife coater, a gate roll coater, a bar coater, a size press, a spray coater or the like.

For forming an image on the recording medium of the invention, first, an image is formed on one surface of the recording medium or images are formed on both surfaces of the recording medium according to ink-jet recording. Then, the recording medium is heated, or heated and pressed by heating means, such as a pair of heating rollers or the like, to provide the film of the outermost surface layer. Thus, a recording medium having excellent weather resistance and no curl is obtained.

Heating belts may also be used as the heating means instead of the heating rollers. Silcone is preferably used as the material for the heating means, because this material has excellent releasability with respect to the latex layer. The heating temperature is preferably 80-200° C.

The recording material of the invention has the ink receiving layer and the outermost surface layer on both surfaces of the substrate. When providing the ink receiving layer and the outermost surface layer on one surface of the substrate and providing only the ink receiving layer on another surface of the substrate, the inorganic pigment leaves the ink receiving layer to adhere to heating means, and the inorganic pigment adhering to the heating means damages the surface of the recording medium. Furthermore, if the outermost surface layer is not provided, curl is produced due to changes in humidity. In addition, the recording medium not having the outermost surface layer tends to adhere to the heating means. Moreover, if the outermost surface layer is provided without providing the ink receiving layer on one surface of the substrate, generation of curl cannot be prevented.

When performing ink-jet recording on one surface of a recording medium, or when recording an image with a relatively small amount of ink on one surface of a recording medium, it is preferable to reduce the amount of coating of the ink receiving layer containing the inorganic pigment on the one surface from the viewpoint of reducing the production cost. In this case, the difference in the amount of coating between two surfaces of the recording medium is preferabley equal to or less than 15 g/m². When performing recording on both surfaces of the recording medium of the invention, the weighing capacity of the substrate is preferably equal to or more than 100 g/m², in order to prevent ink from penetrating into the opposite surface of the recording medium.

Description will now be provided of examples of recording media. These examples are for the purpose of explaining the present invention. Therefore, the present invention is not limited to these examples.

### EXAMPLE 1

Alumina hydrate was used for the ink receiving layer containing an inorganic pigment. Samples were prepared in the following manner. Aluminum octaxide was synthesized according to a method described in U.S. Pat. No. 4,242,271, and alumina slurry was manufactured by hydrolyzing the obtained aluminum octaxide. Water was added to the alumina slurry until the percentage of solid alumina hydrate became 5%. Then, after aging the alumina slurry for 10 hours while raising the temperature to 80° C., the resultant colloidal sol was subjected to spray drying to obtain alumina hydrate. This alumina hydrate was then mixed/dispersed in ion-exchange water, and was adjusted to pH 10 using nitric acid. A colloidal sol was obtained after performing aging for 5 hours. This colloidal sol was desalted and then deflocculated by adding acetic acid. This alumina hydrate colloidal sol was condensed to obtain a solution having 15 weight % of alumina hydrate.

On the other hand, polyvinyl alcohol (trade name: PVA117, made by Kuraray Co., Ltd.) was dissolved in ion-exchange water to obtain a solution having 10 weight % of polyvinyl alcohol.

The above-described two kinds of solutions were mixed with the weight ratio of ten solid parts of alumina hydrate to one solid part of polyvinyl alcohol. The mixture was stirred to obtain a dispersion solution (1).

This dispersion solution (1) was coated on paper, serving as the substrate, having a weighing capacity of 150 g/m² so as to provide an amount of coating after being dried of 30 g/m², to form a coated layer.

A vinyl chloride-vinyl acetate latex having a solid component of 15 weight % (trade name: Vinyblan, made by Nisshin Kagaku Kogyo Kabushi Kaisha) (termed a dispersion solution (2)) was coated on the above-described alumina layer, to form a porous latex layer having an amount of coating after being dried of 5 g/m². On another surface of the paper, also, a coated layer of 30 g/m² was formed by coating the dispersion liquid (1), and a porous latex layer having an amount of coating after being dried of 5 g/m² was formed thereon by coating the dispersion liquid (2).

Evaluation of curl was performed in the following manner.

An A4-size recording medium before ink-jet recording was horizontally placed with a surface to be subjected to ink-jet recording in an upward state in an environment of a temperature of 30° C. and a relative humidity of 80%, and the raised amounts of four corners of the recording medium after being left for 24 hours were measured.

The outermost latex surface layer was heated and pressed after ink-jet recording on the recording medium to provide a film. The recording medium after ink-jet recording was horizontally placed with the surface subjected to ink-jet recording in an upward state in an environment of a temperature of 30° C. and a relative humidity of 80%, and the raised amounts of four corners of the recording medium after being left for 24 hours were measured.

The outermost latex surface layer was heated and pressed using a pair of rubber rollers, each comprising mirror-polished LTV silicone rubber 0.5 mm thick coated on HTV silicone rubber 2 mm thick, and passing the recording medium between the rollers at a conveying speed of 14 mm/sec and with a roller surface temperature of 170° C., to provide a transparent film.

Table 1 illustrates the results of measurements.

TABLE 1

| | | Raised amount after |
|---|---|---|
| | Raised amount before | forming the film of |
| | ink-jet recording (mm) | the latex layer (mm) |
| Example 1 | 0 | 0 |
| Example 2 | 0 | 0 |
| Example 3 | 0 | 0 |
| Comparative | 50 | 30 |
| Example 1 | | |
| Comparative | 30 | 20 |
| Example 2 | | |

### EXAMPLE 2

The alumina hydrate dispersion liquid (1) and the latex dispersion liquid (2) used in Example 1 were coated on paper, serving as the substrate, having a weighing capacity of 150 g/m² as in Example 1. The amount of coating of the outermost latex surface layer was 5 g/m² on each of both surfaces of the paper. The amount of coating of the ink receiving layer containing alumina hydrate was 30 g/m² on one surface (to be subjected to printing) of the paper, and 15 g/m² on another surface of the paper, to obtain a recording medium. Evaluation of curl of the recording medium was performed in the same manner as in Example 1. The results of measurements are shown in Table 1.

### Example 3

The alumina hydrate dispersion liquid (1) and the latex dispersion liquid (2) used in Example 1 were coated on baryta paper, serving as the substrate, obtained by coating a layer containing barium sulfate having a weighing capacity of 20 g/m² on paper having a weighing capacity of 150 g/m². The surface coated with the barium sulfate layer was used as the surface to be subjected to printing. A recording medium was obtained by coating an ink receiving layer containing alumina hydrate with an amount of coating of 30 g/m² and an outermost latex surface layer thereon with an amount of coating of 5 g/m², and coating a layer containing alumina hydrate with an amount of coating of 15 g/m² and an outermost latex surface layer thereon with an amount of coating of 5 g/m² on another surface. Evaluation of curl of the recording medium was performed in the same manner as in Example 1. The results of measurements are shown in Table 1.

### COMPARATIVE EXAMPLE 1

The alumina hydrate dispersion liquid (1) and the latex dispersion liquid (2) used in Example 1 were coated only on one surface of paper, serving as the substrate, having a weighing capacity of 150 g/m² as in Example 1. A recording medium was obtained by coating an ink receiving layer containing alumina hydrate with an amount of coating of 30 g/m², and coating a latex layer thereon with an amount of coating of 5 g/m². Evaluation of curl of the recording medium was performed in the same manner as in Example 1. The results of measurements are shown in Table 1.

### COMPARATIVE EXAMPLE 2

The alumina hydrate dispersion liquid (1) used in Example 1 was used. An ink receiving layer containing alumina hydrate was coated only on one surface of paper, serving as the substrate, having a weighing capacity of 150 g/m² as in Example 1 with an amount of coating of 30 g/m². This surface was used as the surface to be subjected to printing. A recording medium was obtained by coating a latex layer on this surface with an amount of coating of 5 g/M² and coating a latex layer on another surface with an amount of coating of 15 g/m² using the latex dispersion liquid (2) used in Example 1. Evaluation of curl of the recording medium was performed in the same manner as in Example 1. The results of measurements are shown in Table 1.

As described above, according to the present invention, by heating and pressing the outermost latex surface layer, it is possible to obtain a uniform transparent latex film, and to obtain an image recording medium which does not curl irrespective of environment where it is left, and which has excellent image recording characteristics and heather resistance, and allows printing on both surfaces of the recording medium.

When performing ink-jet recording only on one surface of a recording medium, or when recording an image having relatively small amount of ink on one surface of a recording medium, by reducing the amount of coating of an ink receivig layer containing an inorganic pigment on the one surface, it is possible to reduce the production cost of the recording medium.

While the present invention has been described with respect to what are presently considered to be the preferred embodiments, it is to be understood that the invention is not limited to the disclosed embodiments. To the contrary, the present invention is intended to cover various modifications and equivalent arrangements included within the spirit and scope of the appended claims. The scope of the following claims is to be accorded the broadest interpretation so as to encompass all such modifications and equivalent structures and functions.

1. A recording medium comprising:
a paper substrate having two surfaces, on both of which are provided an ink receiving layer containing an inorganic pigment and an outermost surface layer consisting of thermoplastic latex resin, in this order,
wherein the outermost latex surface layer forms a transparent film upon heating of the recording medium.

2. A recording medium according to claim 1, wherein the inorganic pigment comprises alumina hydrate.

3. A recording medium according to claim 1, wherein the difference in the amount of coating between said ink receiving layers on the two surfaces of the substrate is equal to or less than 15 g/m².

4. A recording method comprising the steps of:
performing ink-jet recording on the recording medium according to claim 1; and
heating the recording medium after the ink-jet recording.

5. A recording method according to claim 4, wherein recording is performed on both surfaces of the recording medium.

6. A recording medium according to claim 1, wherein the latex resin is vinyl chloride-vinyl acetate latex resin.

7. A print obtained by a process comprising the steps of:
(i) providing a recording medium according to claim 1;
(ii) applying an ink to the recording medium by an ink-jet recording system;
(iii) heating both of the outermost latex surface layers of the recording medium resulting from step (ii) so that the outermost latex surface layers form transparent films.

8. A print according to claim 7, wherein pressure is applied to the recording medium at the same time as heating in step (iii).

9. A print comprising:
a substrate having two surfaces, on both of which are provided an ink receiving layer containing an inorganic pigment and a layer consisting of latex resin, in this order,
wherein an image is formed on at least one of the ink receiving layers, and
wherein the layer consisting of latex resin forms a transparent film upon heating of said print.

10. A curl-controlling method comprising the steps of:
(i) providing the recording medium according to claim 1,
(ii) heating both of the outermost latex surface layers of the recording medium to provide transparent films.

11. A curl-controlling method according to claim 10, wherein pressure is applied to the recording medium at the same time as heating in step (ii).

12-17. (canceled)
